(19) United States
(12) Patent Application Publication
(10) Pub. No.: US 2013/0008801 A1
(43) Pub. Date: Jan. 10, 2013

(54) METHODS AND COMPOSITIONS FOR APPLICATIONS RELATED TO MICROBIOLOGICALLY INFLUENCED CORROSION

(76) Inventor: Tingyue Gu, Athens, OH (US)

(21) Appl. No.: 13/635,432

(22) PCT Filed: Mar. 16, 2011
(86) PCT No.: PCT/US11/28673

§ 371 Date: Sep. 16, 2012

Related U.S. Application Data
(60) Provisional application No. 61/314,567, filed on Mar. 16, 2010.
(60) Provisional application No. 61/314,565, filed on Mar. 16, 2010.

(51) Int. Cl. G01N 17/02; G01N 27/40

(52) U.S. Cl. 205/776.5; 205/775.5; 204/403.06

(57) ABSTRACT

Methods and compositions for applications related to the microbiologically influenced corrosion (MIC) are provided. MIC is becoming increasingly important, especially to the oil and gas industry due to water flooding practice and aging pipelines. The lack of understanding of the fundamental mechanisms in MIC have greatly hindered the development of reliable prediction and new mitigation methods. This disclosure demonstrates how a biocatalytic cathodic sulfate reduction (BCSR) theory, together with bioenergetics, electrochemical kinetics, and mass transfer, can be used with regard to MIC. The discovery of MIC promoters (that are electron mediators) allows for a new detection tool for more accurate assessment of MIC pitting, and potential new mitigation methods that targets the promoters or microorganisms that secrete these promoters. An MFC device to detect the presence of MIC promoters is provided. When accelerated MIC pitting is desired, such as destruction of undersea munitions or accelerated MIC lab tests, MIC promoters can be added.

### CROSS-REFERENCES TO RELATED APPLICATIONS

This application is a 35 U.S.C. §371 National Phase Application of International Application No. PCT/US11/28673, filed Mar. 16, 2011, which claims priority to, and the benefit of, U.S. Provisional Application No. 61/314,565, filed on Mar. 16, 2010, and U.S. Provisional Application No. 61/314,567, filed on Mar. 16, 2010, which are both incorporated by reference herein in their entirety.

### BACKGROUND

Microbiologically influenced corrosion (MIC) causes billions of dollars in damages each year to the oil and gas industry as well as water utility and other industries.¹ It is becoming more important today due to increased water flooding practice (that could introduce bacteria and nutrients to a system) to increase well pressures.

Many researchers have attempted to explain MIC mechanisms in different ways. The prevailing mechanism is the so-called classic cathodic depolarization theory (CDT) for MIC due to sulfate reducing bacteria (SRB) initiated by von Wolzogen Kuhr and Vlugt vander in 1934.² This theory was adopted by numerous publications on MIC.^{1,3,4,5} It uses the following reactions to explain SRB corrosion.

Anodic reaction (iron dissolution)

4Fe→4Fe²⁺+8e⁻ (1)

Dissociation of water

8H₂O→8H⁺+80H⁻ (2)

Cathodic reaction

8H⁺+8e^{-→}8H_{ads} (3)

Cathodic depolarization by hydrogenase

8H_{ads}(→4H₂)→8H⁺+8e⁻ (4)

Sulfate reduction by SRB

SO₄²⁻+8H⁺+8e⁻→S²⁻+4H₂O (5)

Corrosion product formation

Fe²⁺+S^{2-→}FeS (6)

Corrosion product formation

3Fe²⁺+60H⁻→3Fe(OH)₂ (7)

Overall reaction

4Fe+SO₄²⁻+4H₂O→3Fe(OH)₂+FeS+20H⁻ (8)

A cathodic reaction (Reaction 3) produces hydrogen atoms that adsorb onto the cathode causing the so-called “cathodic polarization.” This stops the corrosion process unless H_{ads} is removed using one or both of the following reactions.

Chemical desorption

2H_{ads}→H₂ (9)

Electrochemical desorption

H_{ads}+H⁺+e⁻→H₂ (10)

Both desorption processes are said to be rate-limiting. High activation energies are required. SRB's hydrogenase enzyme converts H_{ads} to H₂ and then H⁺, thus causes cathodic depolarization. This enzyme is a protein that catalyzes the conversion by lowering the activation energy.⁶ CDT assumes multiple reactions that are difficult to implement in a mechanistic model. The critical role of an SRB biofilm as a surface-active biocatalyst is overlooked, making it difficult to explain many MIC phenomena. CDT cannot explain why some hydrogenase-negative SRB also causes MIC.

Until recently, there has been no mathematical mechanistic model for MIC pitting prediction due to a lack of understanding of complicated MIC mechanisms. In fact, many people questioned whether it would ever become possible. A breakthrough came when Gu et al.⁷ introduced an electrochemical kinetics and bass transfer based mechanistic model using a new biocatalytic cathodic sulfate reduction (BCSR) theory. The model was solved numerically and implemented in an MIC software program. It assumes that a corrosive SRB (sulfate-reducing bacteria) biofilm is present on an iron surface causing the following reactions to go forward due to biocatalysis.

Anodic:

4Fe→4Fe²⁺+8e⁻ (Iron dissolution) (1)

Cathodic:

SO₄²⁻+9H⁺+8e⁻→HS⁻+4H₂O (BCSR) (11)

Reaction 11 reflects the half reaction of sulfate reduction from sulfate to sulfide. Some species were added solely to balance the charges and elements in order to be consistent with other reactions in this work. One should not interpret Reaction 11 strictly as converting proton to hydroxide because the actual sulfate reduction in SRB is coupled with other biochemical reactions. In CDT theory, the hydrogenase enzymes help make the electrons released in Reaction 1 available for utilization by Reaction 11. A non-hydrogenase chemical labeled as an “MIC promoter” can achieve the same result more efficiently, thus moving Reactions 1 and 11 forward causing more severe MIC pitting corrosion. Such an MIC promoter is actually an electron mediator. It is a redox active chemical that serves as an electron carrier to transport the electrons released by iron dissolution from outside the SRB cells to the SRB cytoplasm for use in sulfate reduction.

The BCSR model has been extended to include acidic pH and organic acids at the pit bottom. SRB metabolites contribute to a low local pH.⁸ Acid producing bacteria (APB) also produce corrosive organic acids and contribute to the local low pH. In addition to the BCSR reaction (Reaction 11), proton and acid reductions can also couple with iron dissolution to cause additional corrosion:

2H⁺+2e⁻→H₂ (Proton reduction) (12)

2HAc+2e⁻→2Ac⁻+H₂ (Free acetic acid reduction) (13)

Free un-disassociated organic acids are represented by free acetic acid in the BCSR model that considers both charge transfer resistance and mass transfer resistance. The Butler-Volmer equation is used to describe charge transfer for both anodic and cathodic reactions. Mass transfer resistance and charge transfer resistance are combined using the classical electrochemical kinetics.⁷ The transient model equations are solved numerically. A software program has been created for mechanistic MIC prediction based on the BCSR theory combined with proton reduction and acid reduction. The model yields, for example, pit growth, pitting rate, mass transfer resistance to charge transfer resistance ratio, contributions from BCSR, proton reduction and free acetic acid reduction, and simulated sweeps.

The BCSR model emphasizes the biocatalytic role of an SRB biofilm that moves the cathodic BCSR reaction forward. It is supported by SRB physiology and biochemistry of sulfate reduction at the molecular level discovered by evolutionary biologists, biochemists and other scientists.^{8,9} This disclosure uses the BCSR theory to explain several long-standing myths in MIC.

### BRIEF DESCRIPTION

Disclosed herein is a method for increasing the pitting rate, weight loss rate, or both as a result of microbiologically influenced corrosion (MIC), involving the addition of an electron carrier to a medium that contains a sample that is at least partially coated by a biofilm wherein, the addition of the electron carrier to the sample increases the rate of MIC.

In some embodiments, an electron carrier is selected from the group consisting of riboflavin, flavin adenine dinucleotide (FAD), metalorganics, methylene blue (MB), thionine, meldola's blue (MelB), 2-hydroxy-1,4-naphthoquinone (HNQ), Fe(III)EDTA, humic acids, anthraquinone-2,6-disulphonate, safranine O, resazurin, viologens, cytochromes, nicotinamide adenine dinucleotide (NAD), nicotinamide adenine dinucleotide phosphate (NADP), ferrocyanide, ferrocene monocarboxylic acid, tetracyanoquino-dimethane, tetrathiafulvalene, bipyridine, 3,4-dihydroxybenzaldehyde, poly(vinylferrocene-co-hydroxyethyl methacrylate), poly(Nacryloylpyrrolidine-co-vinylferrocene), acryl amide copolymers, and poly(glycidyl methacrylate-co-vinylferrocene).

The medium, which contains the sample, is selected from the group consisting of an aqueous solution, oil, and fuel. The aqueous solution may be comprised of at least one of the following: magnesium sulfate (MgSO₄), sodium citrate, calcium sulfate (CaSO₄), ammonium chloride (NH₄C1), dipotassium phosphate (K₂HPO₄), sodium lactate (NaC₃H_{S}O₃), yeast extract, and ammonium iron(II) sulfate Fe(NH₄)₂(SO₄)₂. The sample from within or in contact with the medium may be either a metal or metal alloy.

In some embodiments, a biofilm at least partially coating the sample may be comprised of at least of one of the following microbes: Methanogens, Enterobacter, Citrobacter, Eubacterium, Clostridium, sulfate reducing bacteria, nitrate reducing bacteria, nitrite reducing bacteria, Desulfobacterales, Syntrophobacterales, thiosulfate reducing anaerobes, tetracholoroethene degrading anaerobes, triethanolamine degrading bacteria, denitrifiers, xylan degrading bacteria, Nitrospirae, Halomonas spp., Idiomarina spp., Marinobacter aquaeolei, Thalassospira sp., Silicibacter sp., Chromohalobacter sp., Bacilli, Comamonas denitrificans, Methanobacteriales, Methanomicrobiales, and Methanosarcinales.

In other embodiments, the medium may comprise additives including, but not limited to, reducers such as any volatile fatty acids (or their anions), alcohols, hexoses, and hydrogen gas. The additives may also include oxidants such as sulfate, bisulfate, nitrate, nitrite, fumarate or dissolved CO₂ as well as minerals necessary for microbial metabolism.

Also disclosed herein is a method for the mitigation of MIC comprising the lowering of an electron carrier level (through chemical inhibition or killing of microbes that secrete the electron carrier) in a medium containing a sample, which would reduce the rate of MIC pitting. The electron carrier in the aforementioned method is selected from the group consisting of riboflavin, flavin adenine dinucleotide (FAD), metalorganics, methylene blue (MB), thionine, meldola's blue (MelB), 2-hydroxy-1,4-naphthoquinone (HNQ), Fe(III)EDTA, humic acids, anthraquinone-2,6-disulphonate, safranine O, resazurin, viologens, cytochromes, nicotinamide adenine dinucleotide (NAD), nicotinamide adenine dinucleotide phosphate (NADP), ferrocyanide, ferrocene monocarboxylic acid, tetracyanoquino-dimethane, tetrathiafulvalene, bipyridine, 3,4-dihydroxybenzaldehyde, poly(vinylferrocene-co-hydroxyethyl methacrylate), poly(Nacryloylpyrrolidine-co-vinylferrocene), acryl amide copolymers, and poly(glycidyl methacrylate-co-vinylferrocene).

In some embodiments, the medium in which MIC mitigation studies and processes are occurring is selected from the group consisting of an aqueous solution with or without emulsified oil or fuel, oil, and fuel. The aqueous solution may be comprised of at least one of the following reducers: volatile fatty acids (or their salt forms), alcohols, hexoses, and hydrogen gas as well as one of the following oxidants: volatile fatty acids (or their salt forms), alcohols, hexoses, and hydrogen gas. The sample, which may be at least partially coated by a biofilm, is obtained from a medium and may be either a metal or metal alloy.

In other embodiments, the biofilm coating the sample comprises at least of one of the following microbes: Methanogens, Enterobacter, Citrobacter, Eubacterium, Clostridium, sulfate reducing bacteria, nitrate reducing bacteria, nitrite reducing bacteria, Pseudomonas, Desulfobacterales, Syntrophobacterales, thiosulfate reducing anaerobes, tetracholoroethene degrading anaerobes, triethanolamine degrading bacteria, denitrifiers, xylan degrading bacteria, Nitrospirae, Halomonas spp., Idiomarina spp., Marinobacter aquaeolei, Thalassospira sp., Silicibacter sp., Chromohalobacter sp., Bacilli, Comamonas denitrificans, Methanobacteriales, Methanomicrobiales, and Methanosarcinales.

Also disclosed herein is a device for measuring the acceleration of microbiologically influenced corrosion (MIC) by the presence of one or more electron carriers, comprise a microbial fuel cell (MFC), which evaluates the voltage and current output generated by the biofilm oxidation of an organic carbon or H₂ coupled with reduction of an oxidant such as oxygen. It may be used to detect the presence of electron carriers. In some embodiments, the MFC may be miniaturized in size. In other embodiments, the MFC voltage and current output may be calibrated with standard pitting rate data using an anaerobic vial containing a culture medium inoculated with SRB. The pitting rate may be obtained by examining the clean coupon surface for largest pit depth after a week or longer of culture.

Additional features and advantages will be set forth in part in the brief description that follows, and in part will be obvious from the specification, or may be learned by practice of the disclosed embodiments. The objects and advantages of the disclosed embodiments will be realized and attained by means of the elements and combinations particularly pointed out in any appended claims. It is to be understood that both the foregoing brief description and the following detailed description are exemplary and explanatory only and are not restrictive of the disclosed embodiments, as may be claimed.

### BRIEF DESCRIPTION OF THE DRAWINGS

The accompanying drawings, which are incorporated in and constitute a part of this specification, illustrate some embodiments of the inventions, and together with the description, serve to explain principles of the inventions.

FIG. 1 shows simulated effects of proton reduction, free acetic acid reduction, and BCSR on overall MIC pit depth on day 365. The pH at the pit bottom in carbon steel is maintained at pH 4 due to a local acetic concentration of 35 ppm.

FIG. 2 shows MIC pit depth comparison with (top) and without (bottom) riboflavin (an MIC promoter) in tests conducted in 125 ml anaerobic vials with Desulfovibrio vulgaris (ATCC 7757 strain). Y-axis is pit depth in microns and x-axis pit position in microns.

FIG. 3 shows an MFC with a corrosive biofilm such as Desulfovibrio vulgaris (ATCC 7757 strain) covering its anode. The anode is kept anaerobic. It is filled with ATCC 1249 with sulfate removed. The cathode is an oxygen cathode. An MIC promoter such as riboflavin added to the anode chamber will increase the current output (measured by a zero resistance ammeter or ZRA) because the electron transfer from the biofilm to the anode is accelerated by the MIC promoter.

### DETAILED DESCRIPTION

The present inventions will now be described by reference to some more detailed embodiments, with occasional reference to the accompanying drawings. These inventions may, however, be embodied in different forms and should not be construed as limited to the embodiments set forth herein. Rather, these embodiments are provided so that this disclosure will be thorough and complete, and will fully convey the scope of the inventions to those skilled in the art.

Unless otherwise defined, all technical and scientific terms used herein have the same meaning as commonly understood by one of ordinary skill in the art to which these inventions belong. The terminology used in the description of the inventions herein is for describing particular embodiments only and is not intended to be limiting of the inventions. As used in the description of the inventions and the appended claims, the singular forms “a,” “an,” and “the” are intended to include the plural forms as well, unless the context clearly indicates otherwise. All publications, patent applications, patents, and other references mentioned herein are incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present inventions. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the inventions are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

“Microbiologically influenced corrosion” shall refer to processes in which any element of a system is structurally or locally compromised due to the action of at least one member of a microbial population.

The expression “increasing the rate,” when used to describe a process applied in a method, refers to the acceleration of MIC pitting, an acceleration of microbial biocatalysis, MIC pitting occurring at a rate greater than 1 millimeter per year (i.e., the typical rate of MIC pitting), or a combination thereof.

“Partially coated,” or “partially covered,” shall mean that any portion of the surface of the sample is covered by a biofilm. In some embodiments the percentage of the coverage of the surface may be 1, 5, 10, 15, 20, 25, 30, 35, 40, 45, 50, 55, 60, 65, 70, 75, 80, 85, 90, 95, or 100 percent.

“Electron carrier,” “electron mediator,” “promoter,” “electron shuttles,” “redox active molecules,” or “MIC promoter” shall mean a molecule that can accept at least one electron from a metal surface and donate it to various molecules om the cell membrane or inside the cell. Examples include, but are not limited to riboflavin, flavin adenine dinucleotide (FAD), metallorganics such as neutral red, methylene blue, thionine, meldol's blue, 2-hydroxy-1,4-naphthoquinone, Fe(III)EDTA, humic acids, anthraquinone-2,6-disulphonate, safranine O, resazurin, viologens, cytochromes, nicotinamide adenine dinucleotide (NAD), nicotinamide adenine dinucleotide phosphate (NADP), ferrocyanide, ferrocene monocarboxylic acid, tetracyanoquino-dimethane, tetrathiafulvalene, bipyridine, 3,4-dihydroxybenzaldehyde, poly(vinylferrocene-co-hydroxyethyl methacrylate), poly(Nacryloylpyrrolidine-co-vinylferrocene), acryl amide copolymers, and poly(glycidyl methacrylate-co-vinylferrocene). The amount of electron carrier added can range from 1 to 10,000 ppm. In some embodiments the amount of electron carrier is selected from the group consisting of 1, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 225, 250, 275, 300, 325, 350, 375, 400, 425, 450, 475, 500, 550, 600, 650, 700, 750, 800, 900, 1000, 1500, 2000, 2500, 3000, 3500, 4000, 4500, 5000, 6000, 7000, 8000, 9000, and 10,000 ppm.

The expression “biofilm(s),” when used to describe a microbial population applied in a method, refers to an aggregate of microorganisms in which cells adhere to adjacent cells, to a surface, or both. These adjacent cells are frequently embedded within a self-produced extracellular matrix of polymeric substances often composed of proteins and polysaccharides. Microbial cells in a biofilm are physiologically distinct from planktonic cells of the same organism, which, by contrast are single cells that may swim or suspended inside a fluid.

The expression “metallorganics,” when used to describe a compound in a method, refers to any one of a series of compound of a certain metal element or a coordination complex formed by the coordination of a ligand to a metal or pre-existing metal complex. Examples of metallorganic compounds include but are not limited to neutral red, Janus Green B, ferrocene, Zieses's salt, methylcobalamin, Vitamin B₁₂, tris(bipyridine)ruthenium(II) chloride, and other related species.

The expression “humic acids,” when used to describe a compound in a method, refers to any one of a series of organic acids produced from the biodegradation of dead organic matter, which are the major constituents of soil, peat, coal, stream beds, dystrophic lakes, and ocean water. Humic acid is not a single acid, but a family of compounds containing arrays of phenolic and carboxylate groups often yielding dibasic and tribasic complexes with ions that are commonly found in the environment.

The expression “viologens,” when used to describe a compound in a method, refers to any one of a series of organic compounds derived from 4,4′-bipyridine.

The expression “cytochromes,” when used to describe a compound in a method, refers to any one of a number of membrane-bound hemoproteins that contain heme groups and carry out electron transport. Cytochromes may be found as monomeric proteins or as subunits of larger enzymatic complexes that catalyze oxidation-reduction processes in biological systems.

The expression “aqueous solution,” when used to describe a compound in a method, refers to a solution in which the solvent is water, including water containing salts, volatile fatty acids, salts of volatile fatty acids, alcohols, hexoses, and hydrogen; ocean or seawater; brackish water; sources of freshwater, including lakes, rivers, stream, bogs, ponds, marshes, runoff from the thawing of snow or ice; springs, groundwater, and aquifers; and precipitation.

The expression “salts,” when used to describe a compound in a method, refers to single compound or series of compounds that when added to an aqueous solution promote biofilm growth. Typical effective amounts of the following salts, magnesium sulfate (MgSO₄), sodium citrate, calcium sulfate (CaSO₄), ammonium chloride (NH₄Cl), dipotassium phosphate (K₂HPO₄), sodium lactate (NaC₃H₅O₃), and ammonium iron(II) sulfate Fe(NH₄)₂(SO₄)₂ effective to promote biofilm growth range from 1 to 10,000 ppm. In some embodiments the amount of salt is selected from the group consisting of 1, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 225, 250, 275, 300, 325, 350, 375, 400, 425, 450, 475, 500, 550, 600, 650, 700, 750, 800, 900, 1000, 1500, 2000, 2500, 3000, 3500, 4000, 4500, 5000, 6000, 7000, 8000, 9000, 10,000, 25,000, 50,000, 75,000, and 100,000 ppm.

The expression “effective amount,” when used to describe an amount of compound applied in a method, refers to the amount of a compound that achieves the desired biological effect, for example an amount that promotes the growth of biofilms.

The expression “yeast extract,” when used to describe a substance applied in a method, refers to various forms of processed yeast products used as nutrients for bacterial culture media.

The expression “oil,” when used to describe a material in a method, refers to any substance that is a liquid at ambient temperature and is hydrophobic but soluble in organic solvents, including but not limited to hexanes, benzene, toluene, chloroform, and diethyl ether. Classes of compounds included within the context of the above definition include vegetable oils, petrochemical oils (e.g., crude and refined petrochemical products), and volatile essential oils (i.e., aroma compounds from plants).

The expression “fuel,” when used to describe a material in a method, refers to any substance that stores energy, including fossil fuels, gasoline, mixtures of hydrocarbons, jet and rocket fuels, and biofuels.

The expression “metal and metal alloy,” when used to describe a substance in a method, refers to any elemental metal or alloy comprised of elemental metals (e.g., brass, bronze, and steel). Examples of metal and metal alloy products include but are not limited to oil pipes, fuel pipes, oil and fuel pumps, oil refineries, oil platforms and other industrial drilling equipment, private and industrial infrastructure, beams, sheeting, prefabricated structures, underwater structures, water pipes, sewage pipes, water pumps, water transfer equipment, water and amusement park equipment, water treatment facilities, wastewater treatment plants, retaining structures (e.g., pools, retaining ponds, and water towers), military installations and structures, military equipment (e.g., submarines and ships), and munitions.

“Microbes” shall mean any and all microorganisms capable of colonizing and/or causing microbiologically influenced corrosion, either directly or indirectly. Examples of microbes that generally colonize and cause damage to pipelines in the gas and oil industries are Methanogens, Enterobacter and Citrobacter bacteria (e.g., E. dissolvens, E. ludwigii, C. farmeri and C. amalonaticus); Eubacterium and Clostridium bacteria (e.g., Clostridium butyricum, Clostridium algidixylanolyticum, Anaeorfilum pentosovorans, Bacteroides sp., Acinebacter sp., Propionibacterium sp.); sulfate reducing bacteria including but not limited to Desulfovibrionales (e.g., Desulfovibrio desulfuricans, Desulfovibrio vulgaris, Desulfovibrio aminophilus); nitrate reducing bacteria (e.g., Thiobacillus ferrooxidans, Gallionella ferruginea), nitrite reducing bacteria (e.g., Thiomicrospira sp.), Desulfobacterales, and Syntrophobacterales; thiosulfate reducing anaerobes (e.g., Geotoga aestuarianis, Halanaerobium congolense, Sulfurospirillum sp.); tetracholoroethene degrading anaerobes (e.g., Sporomusa ovata); triethanolamine degrading bacteria (e.g., Acetobacterium sp.); denitrifiers (e.g., Acidovorax sp., Pseudomonas sp.); xylan degrading bacteria; Nitrospirae; Halomonas spp.; Idiomarina spp.; Marinobacter aquaeolei; Thalassospira sp.; Silicibacter sp.; Chromohalobacter sp.; Bacilli (e.g., Bacillus spp. Exiguobacterium spp.); Comamonas denitrificans; Methanobacteriales; Methanomicrobiales; Methanosarcinales. Examples of microbes that generally colonize and cause damage to pipelines in other industries are: Staphylococcus aureus, Methicillin-resistant Staphylococcus aureus (“MRSA”), Escherichia coli, Enterococcus fecalis, Pseudomonas aeruginosa, Aspergillus, Candida, Clostridium difficile, Staphylococcus epidermidis, and Acinobacter sp.

The expression “acid,” when used to describe a substance in a method, refers to any substance that reacts with a base. Aqueous acids commonly have a pH of less than 7, and may be defined properly under the Arrhenius, Bronsted-Lowry, and the Lewis definition. Common examples of acids include acetic acid, sulfuric acid, nitric acid, hydrochloric acid, perchloric acid, tartaric acid, and phosphoric acid. The acid may be added to the surface of the metal or metal alloy or to the medium of interest. The amount of acid to be added should maintain a functionally useful pH between 3 and 7. The amount of acid added can range from 1 to 10,000 ppm depending upon the pKₐ and concentration of the acidic reagent. In some embodiments the amount of acid is selected from the group consisting of 1, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 225, 250, 275, 300, 325, 350, 375, 400, 425, 450, 475, 500, 550, 600, 650, 700, 750, 800, 900, 1000, 1500, 2000, 2500, 3000, 3500, 4000, 4500, 5000, 6000, 7000, 8000, 9000, and 10,000 ppm.

The expression “volatile fatty acids,” when used to describe a substance in a method, refers to any organic substance that displays acidic properties. The most common volatile fatty acids are carboxylic acids, whose acidity is associated with the carboxyl group (—COOH). Common examples of volatile fatty acids are acetic acid, propanoic acid, butyric acid, lactic acid, and fumaric acid The acid may be added to the surface of the metal or metal alloy or to the medium of interest. The amount of acid to be added should maintain a functionally useful pH between 3 and 7. The amount of organic acid added can range from 1 to 10,000 ppm depending upon the pKₐ and concentration of the acidic reagent. In some embodiments the amount of organic acid is selected from the group consisting of 1, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 225, 250, 275, 300, 325, 350, 375, 400, 425, 450, 475, 500, 550, 600, 650, 700, 750, 800, 900, 1000, 1500, 2000, 2500, 3000, 3500, 4000, 4500, 5000, 6000, 7000, 8000, 9000, and 10,000 ppm.

“Inhibit” or “mitigate” shall mean disinfect, inhibit, damage, eliminate, reduce, kill, or a combination thereof.

“Lowering” in the context of MIC mitigation shall mean an effective reduction in the thickness of the biofilm, a decrease in the effective concentration of the microbe, a reduction in the biocatalytic activity of the biofilm, a reduction of the rate of MIC pitting, a decreased rate of microbial proliferation, or a combination thereof.

“Microbial fuel cell (MFC)” shall mean, a device that generates an electricity output by splitting a redox reaction into two half reaction. One is anodic reaction that is organic carbon or H₂ oxidation reduction catalyzed by a biofilm and the other cathodic reaction that is the reduction of an oxidant such as oxygen, sulfate, nitrate, nitrite catalyzed by a metal catalyst such as platinum or another biofilm.

The expression “electrochemical,” when used to describe a property in a method, refers to the study of chemical or biochemical reactions which take place in solution at the interface of an electron conductor and an ionic conductor, and which involves electron transfer between the electrode and the electrolyte species in solution.

Microbiologically influenced corrosion causes billions of dollars in damages each year to the oil and gas industries as well as water, utility, and other industries. Although research related to MIC pitting has been ongoing for decades, until recently, there has been no mathematical mechanistic model for MIC pitting prediction due to the lack of understanding of complicated MIC mechanisms. The BCSR model incorporates electrochemical kinetics and mass transfer processes into a working model that assumes that the surface of a sample is at least partially coated by a biofilm. As part of this theory, it is assumed that the biofilm present on the sample accelerate the overall reactions found in equation 1 and 11 via biocatalysis (e.g., hydrogenase activity of SRBs), increasing the rate at which MIC pitting corrosion occurs.

It is disclosed herein that addition of non-hydrogenase, electron carriers to a medium containing a sample may serve as a valuable method for the study of MIC via acceleration of the corrosion process, reducing experimental duration and allowing an increase in sampling frequency. It is believed that various additives and environmental factors may contribute to the rate of MIC. Contemplated herein are a series of factors including the addition of salts to the growth medium, metal type, microbial combinations studied, and the presence of organic acids or corrosive anions as additives, which may contribute to the formation of localized environments attributing to the accelerate of MIC. Although it has been observed in the lab and in the field that the presence of planktonic SRB does not necessarily correlate to MIC pitting, in BCSR theory, MIC pitting is due directly to the sessile SRB cells that are actually located on the surface of the metal. In further support of the theory that localized environments influence the overall rate of MIC pitting, modeling experiments have shown that the presence of an organic acids influence the depth of MIC pitting when compared to pitting studies lacking acidic additives.

It is believed that reduction of electron carrier concentration would result in the mitigation of MIC. The method consists of reducing the concentration of electron carriers in solution and by inhibiting microbes that express electron carriers, wherein the reduction of electron carriers results in a decrease of MIC. It is expected, that by reducing the concentration of electron carriers, that less rigorous treatments will be required to eliminate microbes involved in MIC, thereby reducing the overall rate of MIC pitting.

To date, methods for the detection of MIC have relied upon the nutritional environment from which the sample has been collected, often times sampling the planktonic microbes, and not the biofilm associated microbes known to cause MIC pitting. Disclosed herein is a microbial fuel cell (MFC) device that evaluates the electrochemical environment from which the sample was taken. An electrochemically aggressive environment means that local fluid concentration of electron carriers is high, accelerating MIC. Electron carriers accelerate electron transfer between a biofilm and a metal surface. They can also make more than one layer of sessile cells on the metal surface capable of accepting electrons from the metal surface. In most cases without electron carriers, only a monolayer of sessile cells are able to accept electrons from the metal surface.

Contemplated herein are novel methods for detection of microbiologically influenced corrosion (MIC). MIC pitting tests and lab assays generally take weeks to complete. A method contemplated herein comprises adding an electron carrier to a culture medium used in MIC pitting tests and lab assays to increase the rate of biofilm catalysis thus shortening test durations for pits on a substrate. In some embodiments the electron carrier is a molecule that can accept and donate at least one electron from a metal surface and to various molecules on the cell outer membrane or inside the cell. In some embodiments the electron carrier is selected from the group consisting of riboflavin, flavin adenine dinucleotide (FAD), metallorganics such as neutral red, methylene blue, thionine, meldol's blue, 2-hydroxy-1,4-naphthoquinone, Fe(III)EDTA, humic acids, anthraquinone-2,6-disulphonate, safranine O, resazurin, viologens, cytochromes, nicotinamide adenine dinucleotide (NAD), nicotinamide adenine dinucleotide phosphate (NADP), ferrocyanide, ferrocene monocarboxylic acid, tetracyanoquino-dimethane, tetrathiafulvalene, bipyridine, 3,4-dihydroxybenzaldehyde, poly(vinylferrocene-co-hydroxyethyl methacrylate), poly(nacryloylpyrrolidine-co-vinylferrocene), acryl amide copolymers, and poly(glycidyl methacrylate-co-vinylferrocene). The amount of electron carrier added can range from 1 to 10,000 ppm. In some embodiments the amount of electron carrier is selected from the group consisting of 1, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 225, 250, 275, 300, 325, 350, 375, 400, 425, 450, 475, 500, 550, 600, 650, 700, 750, 800, 900, 1000, 1500, 2000, 2500, 3000, 3500, 4000, 4500, 5000, 6000, 7000, 8000, 9000, and 10,000 ppm. In other embodiments the present method may be coupled with known methods that increase the rate of MIC.

Also contemplated herein a method for the detection of the presence of any such electron carrier in a fluid sample, wherein the presence of an electron carrier indicates that MIC pitting can be accelerated. A system with such a fluid requires more stringent MIC treatment such as biocide dosing and or scrubbing. Detection of such electron carriers can be performed using chemical analysis, electrochemical sensors (such as an MFC), or both. In some embodiments the method comprises determining the relative concentration of the total amount of electron carriers present in a sample. In some embodiments the higher the relative concentration of electron carriers may correspond to a higher level of MIC. In other embodiments the method comprises determining the relative current in the fluid sample as an alternative to measuring the total concentration of electron carriers. In some embodiments a higher relative current may correspond to a higher level of MIC.

In other embodiments the method comprises adding a microorganism that secretes an electron carrier to increase the rate of MIC. In some embodiments the substrate is a metal coupon commonly used in MIC pitting tests or lab assays. In other embodiments the substrate can be a field sample from a pipeline. In other embodiments the present method may be coupled with known methods that increase the rate of MIC. In some embodiments the microorganism secreting an electron carrier may be genetically engineered to overexpress the endogenous electron carrier. In some embodiments the microorganism secreting an electron carrier may be genetically engineered to express an exogenous electron carrier.

Also contemplated herein are methods for the mitigation of MIC. The method comprises inhibiting microbes that express electron carriers, wherein the reduction of electron carrier concentration results in a decrease of MIC. By inhibiting microbes that express electron carriers it is contemplated that less rigorous treatment of sulfate reducing bacteria (SRB) will be needed.

Also contemplated herein are methods for accelerating decomposition of undersea munitions and metal infrastructure. The method contemplated herein comprises adding a microorganism that secretes an electron carrier to increase the rate of MIC on the munitions or metal infrastructure, wherein the MIC results in accelerated destruction of the munitions or metal infrastructure. In some embodiments the secreted electron carrier is selected from the group consisting of riboflavin, flavin adenine dinucleotide (FAD), metallorganics such as neutral red, methylene blue, thionine, meldol's blue, 2-hydroxy-1,4-naphthoquinone, Fe(III)EDTA, humic acids, anthraquinone-2,6-disulphonate, safranine O, resazurin, viologens, cytochromes, nicotinamide adenine dinucleotide (NAD), nicotinamide adenine dinucleotide phosphate (NADP), ferrocyanide, ferrocene monocarboxylic acid, tetracyanoquino-dimethane, tetrathiafulvalene, bipyridine, 3,4-dihydroxybenzaldehyde, poly(vinylferrocene-co-hydroxyethyl methacrylate), poly(nacryloylpyrrolidine-co-vinylferrocene), acryl amide copolymers, and poly(glycidyl methacrylate-co-vinylferrocene). The amount of electron carrier secreted can range from 1 to 10,000 ppm. In some embodiments the amount of electron carrier secreted is selected from the group consisting of 1, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 225, 250, 275, 300, 325, 350, 375, 400, 425, 450, 475, 500, 550, 600, 650, 700, 750, 800, 900, 1000, 1500, 2000, 2500, 3000, 3500, 4000, 4500, 5000, 6000, 7000, 8000, 9000, and 10,000 ppm. In other embodiments the present method may be coupled with known methods that increase the rate of MIC. In some embodiments the microorganism secreting an electron carrier may be genetically engineered to overexpress the endogenous electron carrier. In some embodiments the microorganism secreting an electron carrier may be genetically engineered to express an exogenous electron carrier.

Although MIC has been established as a research field for many decades and hundreds of papers have been published by numerous research groups, there are quite a few long-standing myths or issues that have yet received satisfactory explanations.

Why do sessile SRB cells attack steel?

SRB cells do not “eat” iron.¹⁰ Ferrous ion is almost always available either as a supplied nutrient in lab tests or as a corrosion product in pipeline fluids. There is no need for SRB cells to obtain iron from steel from a nutritional point of view. There must be some kind of advantage for SRB to attack iron. Bioenergetics¹¹ is a critically important theory in the studying microbial metabolism. It is also essential in explaining microbial behavior in MIC. Some SRB biofilms are known to be very dense.¹² It may limit organic carbon (such as lactate) diffusion to the steel surface. On the other hand, sulfate tends to be more available because it is usually available at a higher concentration in the bulk phase thus providing a larger mass transfer driving force. In order to perform sulfate reduction at the steel surface, sessile SRB cells on the surface relies on the electrons donated by iron dissolution instead of those from organic carbon oxidation because the latter may not be available locally. The standard (reduction) potential of iron (−0.45V) is close to those of lactate (−0.43V) and formate (−0.43V), and significantly more negative than those of acetate (−0.29V), butyrate (−0.28V), and propionate (−0.28V). Thermodynamically speaking, iron oxidation is at least equally favored by SRB compared to the aforementioned common organic carbons. The redox reaction from the two half electrode reactions of BCSR (Reaction 11) and iron dissolution (Reaction 1) combined have a negative Gibbs free energy (ΔG^{o′}≈−200 kJ/mol sulfate). This means the overall redox reaction is thermodynamically favorable (i.e., exergonic or energy producing). However, a thermodynamically favorable reaction does not necessarily proceed forward at an appreciable rate if the kinetics is too slow which is the case for sulfate reduction. This reaction must rely on the biocatalysis of the hydrogenase enzyme system in SRB.¹³⁻¹⁵

Sessile SRB cells attack the steel to obtain electrons in the redox reaction that is bioenergetically beneficial in SRB metabolism. The energy generated by the redox reaction is useful when used as maintenance energy in the absence of organic carbon or when the supply of organic carbon is locally limited.

What is the reason that planktonic SRB cell count usually does not correlate with MIC pitting?

It has been observed in the lab and in the field that the presence of SRB in the liquid phase does not necessarily indicate MIC pitting.¹⁶ Even when there is MIC pitting, it appears that the planktonic cell count is not directly related to pit growth.⁸ In the BCSR theory, MIC pitting is due to the sessile SRB cells right on a steel surface (not those sessile SRB cells that are away from the surface).¹⁷ These sessile cells are capable of accepting the electrons donated by the iron dissolution reaction. In the liquid medium, the electrons needed for sulfate reduction by planktonic SRB cells are provided by carbon source oxidation.¹⁸ The redox reaction can be explained by Reaction 14 using lactate as a representative carbon source.

SO₄²⁻+2CH₃CHOHCOO⁻→2CH₃COO⁻+2CO₂+HS⁻+OH⁻+H₂O (14)

This redox reaction happens in the cytoplasm of the cell. It does not need additional electrons. In fact, electrons from iron dissolution on a steel surface cannot “swim” in the liquid medium to be absorbed by the planktonic cells in the bulk fluid because it is a common knowledge to electrochemists that an aqueous medium is a very poor electron conductor.

If the corrosive chemicals produced by planktonic SRB such as hydrogen sulfide and organic acids contribute significantly to pitting underneath biofilms, the planktonic cell count would be a factor. However, such contribution may be limited because sessile cells are much denser than planktonic cells, thus possibly generating much more H₂S locally.

Does a thicker SRB biofilm lead to more severe MIC pitting?

Some existing MIC models^{19,20} relate the amount of sessile cells in an SRB biofilm to pit growth. The BCSR model has a very different view. In biofilm catalysis, it has widely known that a surface electrochemical reaction can only be catalyzed by the sessile cells that are directly or extremely close to the surface. In MIC due to sulfate reduction, this means that only these sessile cells are capable of BCSR and accept the electrons donated by iron dissolution. The other sessile cells in the bulk of the SRB biofilm cannot accept such electrons because a biofilm is a very poor electron conductor. Instead, these sessile cells carry out sulfate reduction by utilizing the electrons donated from organic carbon oxidation if the organic carbon diffuses to that biofilm depth. The ability to carry out BCSR relies on the surface SRB cell density and activities rather than the biofilm thickness. This means MIC pitting from BCSR does not benefit from a thicker SRB biofilm. In fact, a thicker biofilm presents a larger mass transfer barrier that may limit the nutrient flow to the steel surface thus reducing the SRB biocatalytic activity.²¹ It also limits the diffusional removal of corrosion products under the biofilm.

A thick biofilm can lead to more severe MIC pitting, if the MIC mechanisms include proton reduction (due to acidic pH), free organic acid reduction or reaction of other corrosive species such as H₂5 because the local amounts of these corrosive species increase with the amount of sessile cells. This aspect should not be confused with BCSR.

Why laboratory MIC pitting rates cannot explain more severe MIC pitting observed in the field.

Lab experiments conducted using pure SRB strains published by various research groups often indicate an MIC pitting rate around 1 mm/yr¹⁹ or lower. Much more aggressive MIC pitting has been indicated by field operators. There are several possible explanations.

First, SRB cells grown on lactate or acetate may produce organic acids in the biofilm causing a high local concentration due to the fact the a biofilm has a much larger cell density compared to that in the liquid phase. A severe pitting case may involve a low local pH and relatively high local concentrations of free organic acids (secreted by APB and/or SRB). One academic MIC research group studied the local pH inside an SRB biofilm using a micro pH sensor.²² They detected very acidic pH in their SRB biofilm.

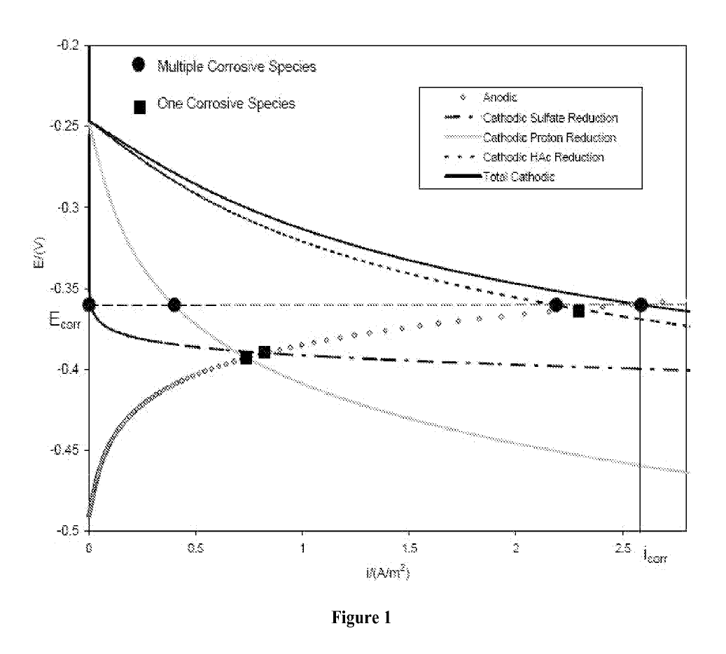

FIG. 1 shows the importance of acidic pH and free organic acids on overall pit depth using computer simulation based on model presented above. The low pH due to dissociated organic acid leads to proton reduction while the un-dissociated free organic acid can also be reduced directly. Effects of proton reduction and free organic acid reduction can be dominating at a sufficiently low pH (e.g., pH 4 in FIG. 1) due to the presence of a significant amount of organic acids at the pit bottom (e.g., 35 ppm acetic acid in FIG. 1). FIG. 1 also shows that individually, BCSR and proton reduction have similar corrosion current densities for the given set of simulation parameters when each of them is present alone without other corrosive species. However, when BCSR, proton reduction and organic acid reduction are all present, BCSR contribution to the overall corrosion is completely negligible under the simulated conditions. Proton reduction and more importantly organic acid reduction dominate.

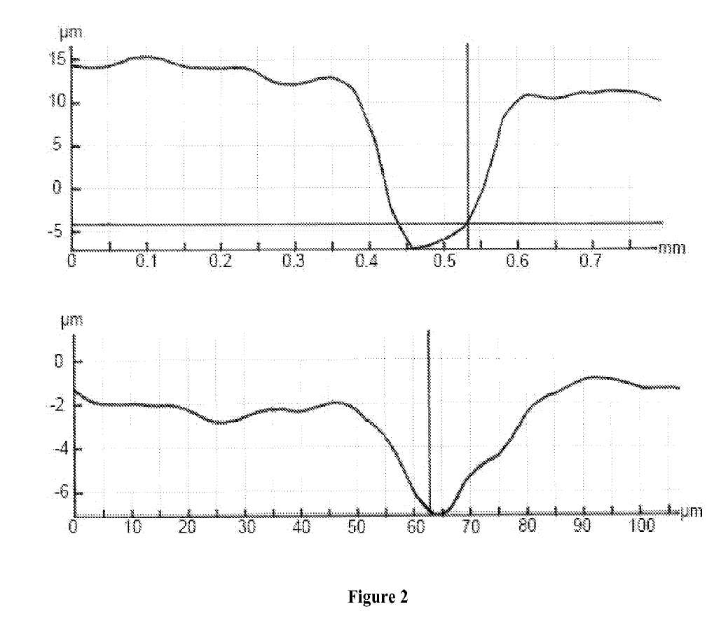

Second, the BCSR theory points to the existence of “MIC promoters.” Guided by this, we have successfully found a class of chemicals that can greatly accelerate BCSR leading to much more severe MIC pitting. FIG. 2 shows the dramatic MIC pit depth increase when an MIC “promoter” (in this case riboflavin) was added to the test medium at a low concentration. In the culture medium used in this work, the “promoter” did not promote planktonic or sessile SRB growth in repeated experiments. This discovery leads to a new aspect of MIC monitoring, and a non-biocidal mitigation method that may even allow us to live with corrosive microbes with much reduced MIC pitting when the promoter's MIC acceleration effect is inhibited.

Finally, there are also other possible explanations for more severe MIC pitting such as CO₂ corrosion, and other types of corrosive microbes (e.g., iron oxidizing bacteria). In stainless steel corrosion involving seawater, MIC may form a synergy with chloride attack leading to very aggressive pitting.³

Why can a biofilm suddenly become more aggressive?

Field operators indicated that they sometimes observe increased MIC pitting when there was seemingly no change in microbial population and nutrients. There are several possible reasons.²³ (a) Planktonic cell counts are typically measured in the field, not sessile cell counts. It is possible that undetected aggressive biofilms have formed causing increased MIC pitting, including APB joining the biofilm community on the steel surface. (b) The presence of the aforementioned MIC “promoter” emerged. Such a chemical compound is naturally occurring and its assay has yet to be applied to MIC detection. Its presence could be due to contribution from a non-corrosive microbe joining the biofilm community.

Are sulfate and organic carbon both necessary for SRB to grow?

SRB can perform dissimilatory sulfate reduction²⁴ to harvest energy when this reduction is coupled with oxidation of a carbon source. SRB are a diverse and versatile category of microbes that are important to evolutionary microbiology. It is known that they can utilize other oxidants such as CO₂ to replace sulfate when sulfate is unavailable.^{9,25} The standard reduction potential of CO₂/CH₄ is sufficiently less positive when coupled with iron oxidation as a redox couple. This means MIC pitting due to SRB utilizing CO₂ is still bioenergetically beneficial for the sessile SRB cells on a steel surface. The energy harvested from such a redox reaction is useful as maintenance energy when an organic carbon source or sulfate is absent locally either due to diffusional limitation or a total lack in the bulk medium. When a very different nutrient is used, SRB needs to produce different enzymes first in order to utilizing CO₂ and this switch can take time. SRB utilization of CO₂ is no longer dissimilatory. Some carbon atoms from CO₂ will be incorporated into the cell mass.⁹

From a viewpoint of evolutionary microbiology, before the earth's atmosphere became aerobic, acetate or lactate was not available in the ocean. When SRB first evolved, they lived an autographic life utilizing nonorganic molecules such as dissolved CO₂ and H₂ for carbon and energy.²⁶ SRB eventually gained the ability to utilize more favorable or abundant carbon and energy sources such as volatile organic acids. SRB cells that are used in lab research and those identified in the field still possess the operons that can be switched on to produce enzymes needed for autotrophic growth.^{9,26}

It must be kept in mind that, other synergistic microbes may also live an autotrophic lifestyle and produce organic carbon to supply SRB. This means an organic carbon such as lactate or acetate may not be needed in the bulk fluid for heterotrophic SRB growth if the synergistic microbes are in the biofilm community. It is plausible that one may not completely rule out the possibility that a barophilic SRB of some sort may eventually appear in a supercritical CO₂ transportation pipeline.

Microbial Fuel Cell as a means to measure electrochemical fluid parameters?

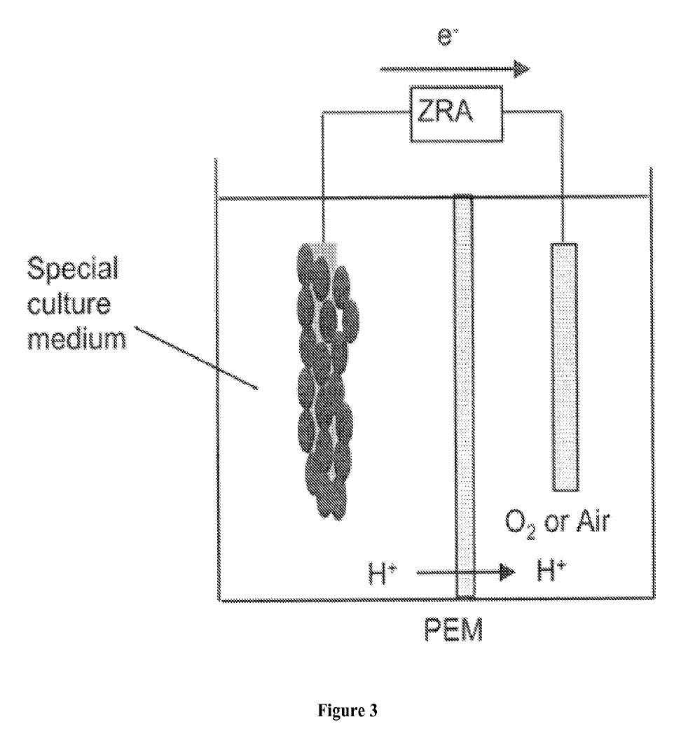

MIC involves the removal of electrons by a corrosive biofilm from elemental iron. The rate of removal determines the MIC corrosion rate. However, direct measurement of the electron removal in MIC cannot be achieved with reasonable accuracy using current technologies. In an MFC containing a corrosive biofilm, electrons are donated from the biofilm to the anode. These electrons flow to an external circuit and their current can be measured directly as shown in FIG. 3. This kind of MFC device can indicate whether the fluid in an oil and gas pipeline or other environment contains electron carriers that accelerate MIC. If such carriers are present, the MFC will produce a higher current density that indicates a more aggressive electrochemical environment for MIC to cause faster and larger pitting damage. In some embodiments, a higher relative current may or may not correspond to a higher level of MIC.

### EXAMPLES

The BCSR theory indicates a bottleneck in MIC due to SRB. To resolve the bottleneck, an electron carrier or mediator was added as an MIC “promoter” into 100 ml anaerobic vials containing SRB and carbon steel coupons. This MIC promoter is not corrosive by itself. After a week of SRB growth, coupons were examined using SEM and IFM (Infinite Focus Microscopy). Desulfovibrio desulfuricans ATCC7757 was used to represent SRB in this work. Table 1 shows the medium composition and Table 2 lists test conditions. Liquid medium was deoxygenated using nitrogen sparging. To study the pits on a carbon steel coupon, the coupon surface was cleaned using an acid solution before SEM and IFM.

TABLE 1

| Parameters | Conditions |
|---|---|
| SRB strain | Desulfovibrio desulfuricans (ATCC 7757) |
| Temperature | 37° C. |
| Culture medium | ATCC 1249 medium |
| Initial pH | 7.0 ± 0.1 |
| Test duration | 7 days |
| Material | C1018 |

TABLE 2

| | | | |
|---|---|---|---|
| Component I | MgSO₄ | 2.0 | g |
| | Sodium Citrate | 5.0 | g |
| | CaSO₄ | 1.0 | g |
| | NH₄Cl | 1.0 | g |
| | Distilled Water | 400 | ml |
| Component II | K₂HPO₄ | 0.5 | g |
| | Distilled Water | 200 | ml |
| Component III | Sodium Lactate | 3.5 | g |
| | Yeast Extract | 1.0 | g |
| | Distilled Water | 400 | ml |
| Component IV | Fe(NH₄)₂(SO₄)₂ | 0.25 | g |
| | Distilled Water | 50 | ml |

Microbial fuel cell SRB-biofilm coated anode for MIC detection (FIG. 3). A field fluid sample is added to a miniature MFC with a strain of SRB biofilm coating the anode. Current density is measured to see whether there is significant increase. If true, it indicates that the sample fluid likely contains electron carriers that can accumulate MIC. This means a more rigorous MIC mitigation scheme should be adopted.

### REFERENCES

### 1. H. A. Videla, Manual of Biocorrosion, Lewis Publishers, Boca Raton, Fla., 1996.

2. C. A. H. von Wolzogen Kuhr, L. S. Vlugt vander, “The graphitization, of cast iron as an electrochemical process in anaerobic soils,” Water, 147-165, 1934.

### 3. W. S. Borenstein, Microbiologically Influenced Corrosion Handbook, Industrial Press, New York, 1994.

### 4. D. Thierry, W. Sand, “Microbially Influenced Corrosion.” In: Corrosion Mechanisms in Theory and Practice, P. Marcus, J. Oudar (eds.), pp. 457-499, Marcel Dekker, New York, 1995.

### 5. H. D. Peck, “Bioenergetic Strategies of the Sulfate-Reducing Bacteria,” in The Sulfate-Reducing Bacteria: Contemporary Perspectives, Odom, J. M., Singleton, R., Jr. (eds.), p. 57, Springer, Berlin-New York, 1993.

### 6. L. G. Ljungdahl, M. W. Adams, L. L. Barton, L. G. Ferry, M. K. Johnson, Biochemistry and Physiology of Anaerobic Bacteria, pp. 20-35, 67-85, 99-113, 252-260, Springer, New York, 2003.

### 7. T. Gu, K. Zhao, S. Nesic, “A Practical Mechanistic Model for MIC Based on a Biocatalytic Cathodic Sulfate Reduction Theory,” CORROSION/2009, Paper No. 09390. (Houston, Tex.: NACE 2009)

8. I. B. Beech, C. C. Gaylarde, “Recent advances in the study of biocorrosion—an overview,” Rev Microbiol, 30, 177-190, 1999.

### 9. J. M. Odom, R. Singleton Jr. (eds.), The Sulfate-Reducing Bacteria: Contemporary Perspectives, pp. 41-76, Springer, Berlin-New York, 1993.

10. S. B. Axelsen, T. Rogne, “Do micro-organisms ‘eat’ metal?” Microbiolgically influenced corrosion of industrial materials, Contract No. BRRT-CT98-5084, 1998.
11. W. A. Hamilton, “Bioenergetics of sulphate-reducing bacteria in relation to their environmental impact,” Biodegradation, 9, 201-212, 1998.

### 12. J. Larsen, B. Dunsmore, C. Schwermer, “Investigation Into Halfdan Water Injection Biofilm Using Chemical Microsensors,” CORROSION/2007, Paper No. 07507. (Houston, Tex.; NACE, 2007)

13. B. Chardin, M. T. Giudici-Orticoni, G. De Luca, B. Guigliarelli, M. Bruschi, “Hydrogenases in sulfate-reducing bacteria function as chromium reductase,” Appl Microbiol Biotechnol, 63, 315-321, 2003.
14. S. Da Silva, R. Basseguy, A, Bergel, “The role of hydrogenases in the anaerobic microbiologically influenced corrosion of steels,” Bioelectrochemistry, 56(1-2) 77-79, 2002.
15. S. Da Silva, R. Basseguy, A., Bergel, “Electron transfer between hydrogenase and 316L stainless steel:identification of a hydrogenase-catalyzed cathodic reaction in anaerobic MIC,” J Electroanal Chem, 561, 93-102, 2004.
16. I. B. Beech, “Sulfate-reducing bacteria in biofilms on metallic materials and corrosion,” Microbiology Today, 30, 115-117, 2003.
17. A. M. Brennenstuhl, T. S. Gendron, R. Cleland, “Mechanisms of underdeposit corrosion in fresh-water cooled austenitic alloy heat exchangers,” Corrosion Science, 35, 699-711, 1993.
18. W. Liamleam, A. P. Annachhatre, “Electron donors for biological sulfate reduction,” Biotechnol Adv, 25(5) 452-63, 2007.
19. C. G. Peng, “Charteriazation and pridiction of biodigradation in aquatic systems.” Ph.D. dissertation, University of Wisconsin-Madison, 1992.
20. O. J. Hao, “Discussion of Modeling of anaerobic corrosion influenced by sulfate-reducing bacteria.” Wat Environ Res, 67(5) 875-876, 1995.
21. M. J. Vieira, L. F. Melo, M.M Pinheiro, “Biofilm formation: hydrodynamic effects on internal diffusion and structure,” Biofouling, 7, 67-80, 1993.
22. L. Ocando, M. F. de Romero, O. Pérez, O. T. de Rincón, E. León, L. Atencio, “Evaluation of pH and H₂S on biofilms generated by sulfate-reducing bacteria: influence of ferrous ions,” CORROSION/2007, Paper No. 07528. (Houston, Tex.: NACE, 2007)
23. R. Zuo, “Biofilms: strategies for metal corrosion inhibition employing Microorganisms,” Appl Microbiol Biotechnol, 76, 1245-1253, 2007.
24. K. H. Nealson, D. Saffarini, “Iron and manganese in anaerobic respiration: environment significance, physiology and regulation,” Annu Rev Microbiol, 48, 311-343, 1994.

### 25. S. Nagpal, S. Chuichulcherm, A. Livingston, L. Peeva, “Ethanol Utilization by Sulfate-Reducing Bacteria: An Experimental and Modeling Study,” Biotechnol Bioeng, 70, 533-543, 2000.

26. J. T. Rosnes, T. Torsvik, T. Lien, “Spore-Forming Thermophilic Sulfate-Reducing Bacteria Isolated from North Sea Oil Field Waters,” Appl Environ Microb, 57, 2302-2307, 1991.

1. A method for increasing the rate of microbiologically induced corrosion (MIC), comprising:
adding an electron carrier to a sample in a medium;
wherein, the sample is at least partially coated by a biofilm, and
wherein, the addition of the electron carrier to the sample increases the rate of MIC.

2. The method of claim 1, wherein the electron carrier is selected from the group consisting of riboflavin, flavin adenine dinucleotide (FAD), metalorganics, methylene blue (MB), thionine, meldola's blue (MelB), 2-hydroxy-1,4-naphthoquinone (HNQ), Fe(III)EDTA, humic acids, anthraquinone-2,6-disulphonate, safranine O, resazurin, viologens, cytochromes, nicotinamide adenine dinucleotide (NAD), nicotinamide adenine dinucleotide phosphate (NADP), ferrocyanide, ferrocene monocarboxylic acid, tetracyanoquino-dimethane, tetrathiafulvalene, bipyridine, 3,4-dihydroxybenzaldehyde, poly(vinylferrocene-co-hydroxyethyl methacrylate), poly(Nacryloylpyrrolidine-co-vinylferrocene), acryl amide copolymers, and poly(glycidyl methacrylate-co-vinylferrocene).

3. The method of claim 1, wherein the medium is selected from the group consisting of an aqueous solution, oil, and fuel.

4. The method of claim 3, wherein the aqueous solution is selected from the group consisting of a solution comprising of water and water soluble components, a biphasic mixture with oil and fuel, and an emulsification with oil and fuel.

5. The method of claim 3, wherein the aqueous solution comprises at least one of volatile fatty acids, salts of volatile fatty acids, alcohols, hexoses, and hydrogen.

6. The method from claim 1, wherein the sample is selected from the group consisting of metal and metal alloy.

7. The method of claim 1, wherein the biofilm comprises at least one of Methanogens, Enterobacter, Citrobacter, Eubacterium, Clostridium, sulfate reducing bacteria, nitrate reducing bacteria, nitrite reducing bacteria, Desulfobacterales, Syntrophobacterales, thiosulfate reducing anaerobes, tetracholoroethene degrading anaerobes, triethanolamine degrading bacteria, denitrifiers, xylan degrading bacteria, Nitrospirae, Halomonas spp., Idiomarina spp., Marinobacter aquaeolei, Thalassospira sp., Silicibacter sp., Chromohalobacter sp., Bacilli, Comamonas denitrificans, Methanobacteriales, Methanomicrobiales, and Methanosarcinales.

8. The method of claim 5, wherein, the volatile fatty acid is selected from the group consisting of acetic acid, propanoic acid, butyric acid, lactic acid, and fumaric acid.

9. A method for the mitigation of MIC comprising:
lowering of an electron carrier level in a medium containing a sample;
wherein the reduction of the electron carrier results in mitigation of MIC.

10. The method of claim 9, wherein the electron carrier is selected from the group consisting of riboflavin, flavin adenine dinucleotide (FAD), metalorganics, methylene blue (MB), thionine, meldola's blue (MelB), 2-hydroxy-1,4-naphthoquinone (HNQ), Fe(III)EDTA, humic acids, anthraquinone-2,6-disulphonate, safranine O, resazurin, viologens, cytochromes, nicotinamide adenine dinucleotide (NAD), nicotinamide adenine dinucleotide phosphate (NADP), ferrocyanide, ferrocene monocarboxylic acid, tetracyanoquino-dimethane, tetrathiafulvalene, bipyridine, 3,4-dihydroxybenzaldehyde, poly(vinylferrocene-co-hydroxyethyl methacrylate), poly(Nacryloylpyrrolidine-co-vinylferrocene), acryl amide copolymers, and poly(glycidyl methacrylate-co-vinylferrocene).

11. The method of claim 9, wherein the medium is selected from the group consisting of an aqueous solution, oil, and fuel.

12. The method of claim 11, wherein the aqueous solution is selected from the group consisting of a solution comprising water and water soluble components, a biphasic mixture with oil and fuel, and an emulsification with oil and fuel, and wherein the aqueous solution further comprises at least one of volatile fatty acids, salts of volatile fatty acids, alcohols, hexoses, and hydrogen.

13. The method of claim 12, wherein, the volatile fatty acid is selected from the group consisting of acetic acid, propanoic acid, butyric acid, and lactic acid.

14. The method of claim 9, wherein the sample is selected from a group consisting of metal and metal alloy, and
wherein, the sample is at least partially coated by a biofilm.

15-20. (canceled)

21. The method of claim 9, wherein the biofilm comprises at least one of Methanogens, Enterobacter, Citrobacter, Eubacterium, Clostridium, sulfate reducing bacteria, nitrate reducing bacteria, nitrite reducing bacteria, Desulfobacterales, Syntrophobacterales, thiosulfate reducing anaerobes, tetracholoroethene degrading anaerobes, triethanolamine degrading bacteria, denitrifiers, xylan degrading bacteria, Nitrospirae, Halomonas spp., Idiomarina spp., Marinobacter aquaeolei, Thalassospira sp., Silicibacter sp., Chromohalobacter sp., Bacilli, Comamonas denitrificans, Methanobacteriales, Methanomicrobiales, and Methanosarcinales.

22. A device for measuring the presence of an MIC promoter comprising:
a microbial fuel cell (MFC), wherein the MFC includes an anode chamber separated from a cathode chamber by a proton exchange membrane, and the anode chamber comprises an anode that is at least partially coated by a microbial biofilm, and the cathode chamber comprises a cathode;
an external circuit electrically connecting the anode and the cathode; and
wherein when a sample medium is added to the anode chamber, a measured increase in current density provides an indication that the sample medium comprises an MIC promoter.

23. The device of claim 22, wherein the MFC is miniaturized in size.

24. The device of claim 22, wherein the MFC is calibrated to an electron carrier, and wherein the electron carrier is selected from the group consisting of riboflavin, flavin adenine dinucleotide (FAD), metalorganics, methylene blue (MB), thionine, meldola's blue (MelB), 2-hydroxy-1,4-naphthoquinone (HNQ), Fe(III)EDTA, humic acids, anthraquinone-2,6-disulphonate, safranine O, resazurin, viologens, cytochromes, nicotinamide adenine dinucleotide (NAD), nicotinamide adenine dinucleotide phosphate (NADP), ferrocyanide, ferrocene monocarboxylic acid, tetracyanoquino-dimethane, tetrathiafulvalene, bipyridine, 3,4-dihydroxybenzaldehyde, poly(vinylferrocene-co-hydroxyethyl methacrylate), poly(Nacryloylpyrrolidine-co-vinylferrocene), acryl amide copolymers, and poly(glycidyl methacrylate-co-vinylferrocene).

25. The device of claim 22, wherein the microbial biofilm comprises at least one of Methanogens, Enterobacter, Citrobacter, Eubacterium, Clostridium, sulfate reducing bacteria, nitrate reducing bacteria, nitrite reducing bacteria, Desulfobacterales, Syntrophobacterales, thiosulfate reducing anaerobes, tetracholoroethene degrading anaerobes, triethanolamine degrading bacteria, denitrifiers, xylan degrading bacteria, Nitrospirae, Halomonas spp., Idiomarina spp., Marinobacter aquaeolei, Thalassospira sp., Silicibacter sp., Chromohalobacter sp., Bacilli, Comamonas denitrificans, Methanobacteriales, Methanomicrobiales, and Methanosarcinales.
